(19) United States
(12) Patent Application Publication
(10) Pub. No.: US 2007/0053213 A1
(43) Pub. Date: Mar. 8, 2007

(54) WIDE-VOLTAGE-RANGE CONVERTER

(75) Inventors: Richard Brune, Furth (DE); Kurt Gopfrich, Erlangen (DE); Hubert Schierling, Erlangen (DE); Gunter Schwesig, Erlangen (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 11/470,418

(22) Filed: Sep. 6, 2006

(30) Foreign Application Priority Data
Sep. 6, 2005 (DE) 10 2005 042 324.8

(51) Int. Cl. H02M 5/45

(52) U.S. Cl. 363/37

(57) ABSTRACT

A wide-voltage-range converter with a power-supply-side converter unit and a load-side converter unit includes a step-up converter electrically connecting the DC voltage sides of the power-supply-side converter unit and the load-side converter unit, respectively. The wide-voltage-range converter further includes a bidirectional switch and a turn-off semiconductor switch as converter unit valves in each phase (R, S, T) of the power-supply-side converter unit. The power-supply-side converter unit also includes a filter on the AC voltage side, whereas the load-side converter unit includes a DC voltage capacitor on the DC voltage side. The wide-voltage-range converter operates at a specified output voltage without derating.

### CROSS-REFERENCES TO RELATED APPLICATIONS

This application claims the priority of German Patent Application, Serial No. 10 2005 042 324.8, filed Sep. 6, 2005, pursuant to 35 U.S.C. 119(a)-(d), the content(s) of which is/are incorporated herein by reference.

### BACKGROUND OF THE INVENTION

The present invention relates to a wide-voltage-range converter having a power-supply-side and load-side converter unit.

Nothing in the following discussion of the state of the art is to be construed as an admission of prior art.

An electric motor having a predetermined motor voltage can be connected to different power supplies. The power supplies differ from one another in terms of their power supply voltages. The essential power supply voltages of a three-phase power supply are 200 V to 240 V, 380 V to 480 V, 500 V to 600 V and 660 V to 690 V. A converter is required for operation of the motor, the converter being connected between a feeding power supply and the motor.

A converter of this type has a converter unit on the power supply side and on the load side, these converter units being linked to one another on the DC voltage side. A self-commutated pulse-controlled converter unit is predominantly used as the load-side converter unit. Various converter units can be used on the power supply side. A commercially available simple converter, also referred to as a frequency converter, has a diode bridge as the power-supply-side converter unit. This uncontrolled power-supply-side converter unit is connected to the DC-voltage-side connections of the self-commutated pulse-controlled converter unit on the DC voltage side by means of a voltage intermediate circuit having at least one capacitor.

If energy is intended to be fed back into the feeding power supply, then a diode rectifier is used, a respective turn-off semiconductor switch being electrically connected in antiparallel with the diodes of the rectifier. The turn-off semiconductor switches are in each case turned on during the current conduction times of the associated diodes, which are determined by the natural commutation instants. On the power supply side, this converter unit controlled at the power supply frequency has a filter having three star- or delta-connected capacitors. The voltage intermediate circuit, which connects the power-supply-side converter unit to the load-side converter unit on the DC voltage side has no capacitors in the case of this converter topology. As a result of the configuration of the power-supply-side converter unit, which is also referred to as the fundamental frequency front end (F³E), this converter is regenerative.

In the case of a further converter topology, instead of a diode rectifier, a self-commutated pulse-controlled converter unit having an inductor in each of the supply lines on the AC voltage side is used as the power-supply-side converter unit. On the DC voltage side, the power-supply-side converter unit, which is also referred to as the active front end (AFE), is electrically conductively connected to the DC-voltage-side connections of the load-side converter unit, in particular of a self-commutated pulse-controlled converter unit, by means of a voltage intermediate circuit having at least one capacitor, preferably an electrolytic capacitor. The use of an AFE as the power-supply-side converter unit means that this converter is congenial to the power supply and regenerative. Moreover, an intermediate circuit voltage is regulated to a predetermined value in a constant fashion.

In the case of a conventional wide-voltage-range converter whose power-supply-side converter unit is embodied in one of the aforementioned topologies (diode rectifier, F³E, AFE), it is necessary to accept a pronounced power derating or else a relatively high power loss. For these reasons, a converter is chosen which, on the power supply voltage side, is adapted to the power supply voltage of a feeding power supply and, on the load side, is adapted to a power requirement of a motor to be driven having a predetermined motor voltage.

It would therefore be desirable and advantageous to provide a wide-voltage-range converter which obviates prior art shortcomings and which no longer exhibits power derating during its operation.

### SUMMARY OF THE INVENTION

According to one aspect of the present invention, a wide-voltage-range converter includes a power-supply-side converter unit having an 3-phase AC input side and a DC output side, the power-supply-side converter unit further including on the AC input side a filter, and for each of the three phases a respective converter unit valve implemented as a bidirectional switch and a turn-off semiconductor switch, a load-side converter unit having a DC input side with a DC voltage capacitor, and a step-up converter electrically connecting the DC output side of the power-supply-side converter with the DC input side of the load-side converter unit.

By virtue of the fact that a bidirectional switch and a turn-off semiconductor switch are provided as converter unit valves of each phase of a power-supply-side converter unit, that the power-supply-side converter unit has a filter on the AC voltage side, and that the power-supply-side converter unit is linked to DC-voltage-side connections of the load-side converter unit of this wide-voltage-range converter on the DC voltage side by means of a step-up converter, a wide-voltage-range converter according to the invention can be connected to a power supply with an arbitrary power supply voltage without power derating occurring. The step-up converter positioned in the voltage intermediate circuit generates an output voltage having a predetermined amplitude on the output side independently of an input voltage whose amplitude has a lower value than the value of the amplitude of the regulated output voltage. As a result, the load-side converter unit is always operated at a constant DC voltage having a predetermined amplitude. By means of the power-supply-side converter unit formed according to the invention, a DC voltage is generated which can assume a value of between zero and a maximum value independently of the power supply voltage of the feeding power supply. This generated DC voltage is the input DC voltage of the step-up converter connected downstream of the power-supply-voltage-side converter unit.

In order that the inductor of the step-up converter occupies a small structural volume, the turn-off semiconductor switches of the converter unit valves of the step-up converter are clocked at high frequency. High frequency denotes a frequency at from at least 20 kHz to hundreds of kHz. The turn-off semiconductor switches of the converter unit valves of the step-up converter advantageously comprise silicon carbide owing to the high clock frequency.

A switch is referred to as a bidirectional switch if it can carry current in both directions and block voltage in both directions. Such bidirectional switches are known in the field of the “matrix converter” converter topology. By means of these bidirectional switches as upper or lower converter unit valves of the power-supply-side converter unit, it is possible, independently of the amplitude of the power supply voltage of the feeding power supply, to generate a DC voltage at the DC-voltage-side connection of the power-supply-side converter unit, which DC voltage is regulated by means of the step-up converter to a predetermined amplitude of the DC voltage for the load-side converter unit. If these bidirectional switches of the power-supply-side converter unit are operated in pulsed fashion, a sinusoidal current can be impressed on the power supply side both by motor and by generator.

The pulse frequency with which the turn-off semiconductor switches of the bidirectional switches are clocked determines the structural volume of the capacitors of the power-supply-side filter. A highest possible pulse frequency with low switching losses is achieved in the embodiment of the bidirectional switch as a switchable diode bridge by virtue of the fact that a field effect transistor made of silicon carbide is provided as the turn-off semiconductor switch. If two turn-off semiconductor switches in the “common emitter mode” or “common collector mode” topology are used as the bidirectional switch, then it is advantageous to embody the freewheeling diodes of the turn-off semiconductor switches in silicon carbide.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an equivalent circuit diagram of a wide-voltage-range converter according to the present invention;

FIG. 2 shows an equivalent circuit diagram of a first embodiment of a bidirectional switch of the power-supply-side converter unit of the wide-voltage-range converter according to FIG. 1; and

FIGS. 3 and 4 show each an equivalent circuit diagram of a further embodiment of a bidirectional switch.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have different inventive entity. Both applications are unique, but incorporate the other by reference. Accordingly, the following U.S. patent application is hereby expressly incorporated by reference. “Wide-Voltage-Range Converter” (Docket No: BRUNE).

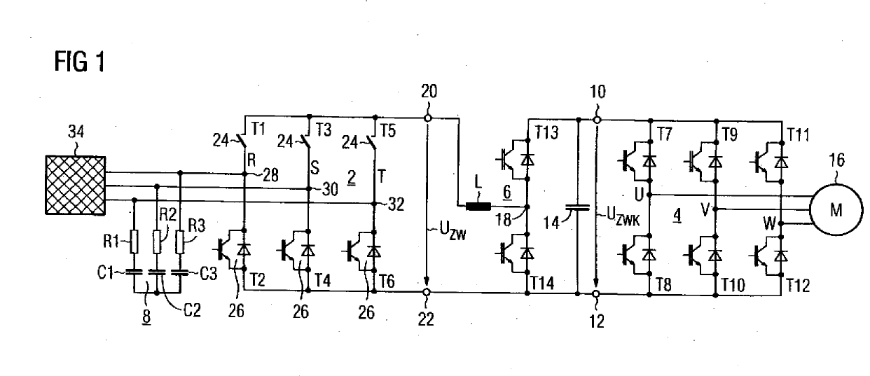

Turning now to the drawing, and in particular to FIG. 1, there is shown an equivalent circuit diagram of a wide-voltage-range converter according to the present invention having a power-supply-side converter unit 2, a load-side converter unit 4, a step-up converter 6 and a power-supply-side filter 8. The power-supply-side converter unit 2 is electrically conductively linked to DC-voltage-side connections 10 and 12 of the load-side converter unit 4 on the DC voltage side by means of the step-up converter 6. A DC voltage capacitor 14, in particular an electrolytic capacitor, is electrically connected in parallel with the DC-voltage-side connections 10 and 12 of the load-side converter unit 4. A motor 16, in particular a three-phase motor, is connected to the output terminals U, V and W of the load-side converter unit 4. A self-commutated pulse-controlled converter unit having in each case a turn-off semiconductor switch, in particular an Insulated Gate Bipolar Transistor (IGBT), as converter unit valves T7-T12 is provided as the load-side converter unit 4.

The step-up converter 6, which, on the DC voltage side, electrically conductively connects the power-supply-side converter unit 2 to the load-side converter unit 4, has two converter unit valves T13 and T14 and an inductor L. The two converter unit valves T13 and T14 each have a turn-off semiconductor switch with an antiparallel-connected diode. A junction point 18 of the two converter unit valves T13 and T14 of the step-up converter 6 is linked to a first connection of the inductor L. A second connection of the inductor L is electrically conductively connected to a DC-voltage-side output connection 20 of the power-supply-side converter unit 2. The DC-voltage-side output connection 22 is directly linked to the DC-voltage-side connection 12 of the load-side converter unit 4. The inductor L may be embodied in two partial inductors or in the form of an inductor having two partial windings, the second partial inductor or partial winding being connected between the points 22 and 12. An output voltage U_{ZW} of the power-supply-side converter unit 2, which is also referred to as intermediate circuit voltage U_{ZW}, is present at the DC-voltage-side output connections 20 and 22. The output voltage U_{ZW} of the power-supply-side converter unit 2 is an input voltage of the step-up converter 6 on the DC voltage side. On the output side, a constant intermediate circuit voltage U_{ZWK} is present at the output of the step-up converter 6, the amplitude of the voltage being regulated to a predetermined value. This regulated intermediate circuit voltage U_{ZWK} is backed up by the DC voltage capacitor 14.

In order that the inductor L of the step-up converter 6 can occupy a small structural volume, the converter unit valves T13 and T14 of the step-up converter 6 must be clocked at the highest possible frequency. If IGBTs are used as turn-off semiconductor switches of the converter unit valves T13 and T14, then diodes made of silicon carbide are used as antiparallel-connected diodes. Instead of IGBTs as turn-off semiconductor switches of the converter unit valves T13 and T14, it is also possible to use field effect transistors (FET), in particular junction FETs or enhancement-mode MOSFETs which are produced from silicon carbide for use in the step-up converter 6 of this wide-voltage-range converter.

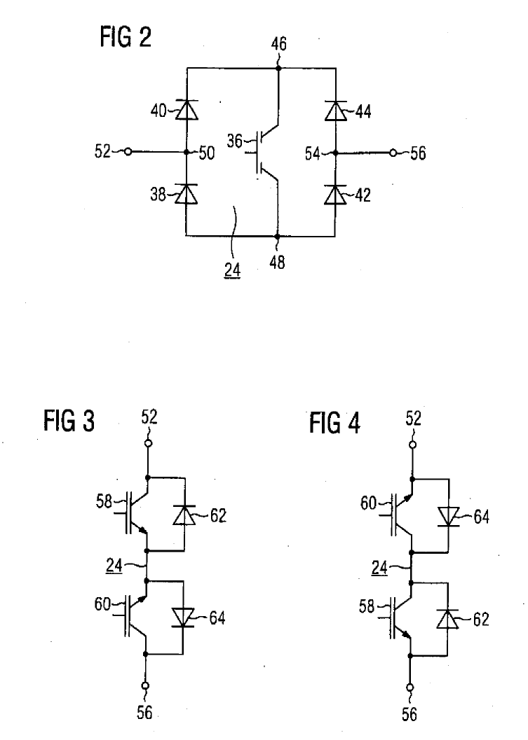

According to the invention, the power-supply-side converter unit 2 has a bidirectional switch 24 and a turn-off semiconductor switch 26 as converter unit valves T1, T2 and T3, T4 and T5, T6 of each phase R, S and T, respectively. In the illustrated embodiment of the power-supply-side converter unit 2, a respective bidirectional switch 24 is provided for the upper converter unit valves T1, T3 and T5. Embodiments for a bidirectional switch 24 are illustrated in greater detail in FIGS. 2 to 4. The turn-off semiconductor switch 26 provided in this embodiment in each case for the lower converter unit valves T2, T4 and TO of the power-supply-side converter unit 2 has an IGBT with an antiparallel-connected diode. The IGBTs of the turn-off semiconductor switches 26 are controlled in such a way that these are in the on state at the natural current conduction times of the corresponding diodes. Consequently, the IGBTs of the turn-off semiconductor switches 26 are driven at the natural commutation instants. A filter 8 is electrically connected in parallel with the power-supply-side input connections 28, 30 and 32 of the power-supply-side converter unit 2. Moreover, the wide-voltage-range converter is connected to a feeding power supply 34 by means of the input connections 28, 30 and 32. The feeding power supply 34 may have a power supply voltage having an amplitude of 200 V to 690 V, by way of example, higher amplitudes of the power supply voltage also being possible. The filter 8 has three capacitors C1, C2 and C3, which here are star-connected capacitors. However, the capacitors may also be delta-connected capacitors. Moreover, the filter 8 has three damping resistors R1, R2 and R3 that are in each case electrically connected in series with a capacitor C1 and C2 and C3, respectively.

An equivalent circuit diagram of a first embodiment of a bidirectional switch 24 of the power-supply-side converter unit 2 of the wide-voltage-range converter in accordance with FIG. 1 is illustrated in more detail in FIG. 2. In accordance with this equivalent circuit diagram, the bidirectional switch 24 has a turn-off semiconductor switch 36 and four diodes 38, 40, 42 and 44. The four diodes 38, 40, 42 and 44 form a bridge circuit. The turn-off semiconductor switch 36 is electrically conductively connected by a connection 46 to the cathode connections of the two diodes 40 and 44, and its second connection 48 is electrically conductively connected to the anode connections of the two diodes 38 and 42. A junction point 50 of the diodes 38 and 40 electrically connected in series forms a first connection 52 of the bidirectional switch 24. A further junction point 54 of the diodes 42 and 44 electrically connected in series forms a second connection 56 of the bidirectional switch 24. A field effect transistor (FET) or an Insulated Gate Bipolar Transistor (IGBT) may be used as the turn-off semiconductor switch 36. From the various types of field effect transistors that are commercially available, either a junction FET or a MOSFET is appropriate for this bidirectional switch 24. An n-channel enhancement-mode MOSFET is illustrated in the equivalent circuit diagram of the bidirectional switch 24. A junction FET, also referred to as a junction field effect transistor (JFET), may also be used instead of the normally off MOSFET.

In order that the power-supply-side filter 8 in accordance with FIG. 1 occupies as far as possible a small structural volume in order that the filter 8 can be integrated in the wide-voltage-range converter, a high clock frequency is required for the operation of the turn-off semiconductor switch 36. In this application, a high clock frequency is understood to mean a frequency from a frequency range of at least 20 kHz to hundreds of kHz, for example 200 kHz. In order that the switching losses remain within an acceptable range, a MOSFET or a JFET made of silicon carbide is used as the turn-off semiconductor switch 36.

FIG. 3 illustrates a second embodiment of the bidirectional switch 24. This is an equivalent circuit diagram of a bidirectional switch 24 in the “common emitter mode” topology. FIG. 4 illustrates a further embodiment of the bidirectional switch 24. This further embodiment of the bidirectional switch 24 is a bidirectional switch 24 in the “common collector mode” topology. These two bidirectional switches 24 in each case have two turn-off semiconductor switches 58 and 60 which are reverse-connected in series. In FIG. 3, the two turn-off semiconductor switches 58 and 60 are reverse-connected in series in such a way that their emitter connections are electrically conductively connected to one another. For this reason, this way in which the two turn-off semiconductor switches 58 and 60 are reverse-connected in series is also referred to as common emitter mode. In FIG. 4, the two turn-off semiconductor switches 58 and 60 are reverse-connected in series in such a way that their collector connections are electrically conductively connected to one another. In accordance with the linking of the collector connections, this circuitry interconnection is referred to as common collector mode. IGBTs are used as turn-off semiconductor switch 58 and 60, the IGBTs respectively having an antiparallel-connected diode 62 and 64. At the connections 52 and 56 of the bidirectional switch 24, it is possible to discern the internal topology of the bidirectional switch. In the case of the bidirectional switch in the “common emitter mode” topology in accordance with FIG. 3, the collector connections of the two turn-off semiconductor switches 58 and 60 form the connections 52 and 56 of the bidirectional switch 24. In accordance with FIG. 4, the emitter connections of the two turn-off semiconductor switches 58 and 60 form the connections 52 and 56 of the bidirectional switch 24. Bidirectional switches 24 of this type are used in a matrix converter in which nine of the bidirectional switches are connected up in a 3×3 matrix.

In order that, with this use of bidirectional switch 24, too, the power-supply-side filter 8 can occupy as far as possible a small structural volume, a high clock frequency is required for the operation of the turn-off semiconductor switches 58 and 60 of the bidirectional switch 24. In order that the high clock frequency can also be realized, diodes 62 and 64 made of silicon carbide are used.

This converter topology according to the invention results in a wide-voltage-range converter without derating with dedicated output voltage. The load-side converter unit 4, in particular a self-commutated pulse-controlled converter unit, can now be optimized in terms of power since a predetermined DC voltage having a regulated amplitude is always present on the DC voltage side independently of the feeding power supply, With this wide-voltage-range converter according to the invention, it is possible to operate a motor, in particular a three-phase motor, having a predetermined power with a defined motor voltage at the important power supplies (3AC200V-240V, 3AC380V-480V, 3AC500V-600V, 3AC660V-690V) in conjunction with a minimized power loss and full power provision in the entire wide-voltage-range. An engineer who would like to use only one type of motor having a predetermined power and a predetermined motor voltage in his machines for driving individual components of the machines can now produce his machine for the wide-voltage-range with this wide-voltage-range converter according to the invention. This eliminates the need to keep a plurality of different converters in stock.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A wide-voltage-range converter, comprising:
a power-supply-side converter unit having an 3-phase AC input side and a DC output side, the power-supply-side converter unit further including on the AC input side a filter, and for each of the three phases a respective converter unit valve implemented as a bidirectional switch and a turn-off semiconductor switch,
a load-side converter unit having a DC input side with a DC voltage capacitor, and
a step-up converter electrically connecting the DC output side of the power-supply-side converter with the DC input side of the load-side converter unit.

2. The wide-voltage-range converter of claim 1, wherein the step-up converter comprises two converter unit valves connected in series at a connection point, and an inductor connected to the connection point of the two converter unit valves.

3. The wide-voltage-range converter of claim 1, wherein the bidirectional switch comprises the turn-off semiconductor switch and four diodes forming a rectifier bridge circuit having respective AC-voltage-side connections and DC-voltage-side connections, wherein the turn-off semiconductor switch is electrically connected to the DC-voltage-side connections and the bidirectional switch is connected to the AC-voltage-side connections.

4. The wide-voltage-range converter of claim 1, wherein the bidirectional switch comprises two turn-off semiconductor switches, and a diode connected antiparallel across each of the turn-off semiconductor switches, and wherein emitter terminals of the two turn-off semiconductor switches are electrically connected to one another.

5. The wide-voltage-range converter of claim 1, wherein the bidirectional switch comprises two turn-off semiconductor switches, and a diode connected antiparallel across each of the turn-off semiconductor switches, and wherein collector terminals of the two turn-off semiconductor switches are electrically connected to one another.

6. The wide-voltage-range converter of claim 1, wherein the side filter comprises three capacitors connected in a star configuration.

7. The wide-voltage-range converter of claim 1, wherein the filter comprises three capacitors connected in a delta configuration.

8. The wide-voltage-range converter of claim 7, further comprising a damping resistor electrically connected in series with each capacitor of the filter.

9. The wide-voltage-range converter of claim 2, wherein the converter unit valves of the step-up converter device comprise a MOS field effect transistor.

10. The wide-voltage-range converter of claim 2, wherein the converter unit valves of the step-up converter device comprise a junction field effect transistor.

11. The wide-voltage-range converter of claim 3, wherein the turn-off semiconductor switch of the bidirectional switch comprises a MOS field effect transistor.

12. The wide-voltage-range converter of claim 9, wherein the MOS field effect transistor is made of silicon carbide.

13. The wide-voltage-range converter of claim 10, wherein the junction field effect transistor is made of silicon carbide.

14. The wide-voltage-range converter of claim 11, wherein the MOS field effect transistor is made of silicon carbide.

15. The wide-voltage-range converter of claim 4, wherein the antiparallel-connected diodes of the two turn-off semiconductor switches of the bidirectional switch are made of silicon carbide.

16. The wide-voltage-range converter of claim 5, wherein the antiparallel-connected diodes of the two turn-off semiconductor switches of the bidirectional switch are made of silicon carbide.
